(19) United States
(12) Patent Application Publication
(10) Pub. No.: US 2003/0031773 A1
(43) Pub. Date: Feb. 13, 2003

(54) Chemical leavening ingredient

(75) Inventor: Carl J. Pacifico, West Milford, NJ (US)

Correspondence Address: HOFFMANN & BARON, LLP, 6900 JERICHO TURNPIKE, SYOSSET, NY, 11791, US

(73) Assignee: Balchem Corporation.

(21) Appl. No.: 09/924,017

(22) Filed: Aug. 7, 2001

(51) Int. Cl. A21D 2/00

(52) U.S. Cl. 426/551

(57) ABSTRACT

An improved leavening agent and method of baking a bread dough with the improved leavening agent provides a bread dough with improved physical characteristics and by allowing the release of a leavening acid or base at the optimal time during baking.

### BACKGROUND OF THE INVENTION

The present invention relates to an ingredient and a method for leavening a bread dough as well as the dough prepared therefrom. More particularly, the present invention relates to a chemical leavening particulate having characteristics which enhance the leavening process.

Bread doughs rely on a leavening system to cause a dough to rise. While many breads rely on a natural leavening system provided by yeast, pre-made bread mixes, pizza shells, and other shelf-stable bread products often rely on chemical leavening systems. The chemical leavening process entails contacting an acid and a base at a certain time to cause a reaction which produces gaseous carbon dioxide (CO₂). Carbon dioxide expands the bread, providing increased volume, a more pleasant taste, and generally gives bread its spongy texture.

Aside from the use of yeast, a number of different chemical leavening systems can be used in bread doughs. The reaction between the acid and base to form carbon dioxide can generally be controlled by manipulating the types of leavening acids or leavening bases which are used in the system. One commonly used chemical leavening system is sodium bicarbonate (base) and sodium acid pyrophosphate (acid). When using chemical leaveners however, it is important to control the time at which the leavening agents become available in the bread dough to react and leaven the dough. It is especially important when dealing with pre-made bread mixtures; which are mixtures in which the ingredients are stored together in a package prior to baking; that the leavening agents do not dissolve prematurely in the mixtures before baking. It is further desirous so that the agents, acids and bases, do not react with each other prior to baking.

Leavening agents are primarily acids and bases. If both leavening agents (acid and base) dissolve in the dough prior to the baking process, carbon dioxide will form, and the leavening agent will not be able to effectively react to leaven the dough at the appropriate time. In order to prevent premature dissolution of leavening agents, it is known to coat them with a protective coating which will prevent leavening activation until heat is applied to the coating to effectively melt the coating and activate the agent. Leavening agents may be coated with some type of edible coating; preferably lipid coatings are used in this capacity.

The lipid coating is melted during the baking process so that the leavening agents, the acid and base, are permitted to contact each other and react. Water in the dough facilitates the leavening process as it provides a solution in which the acid and base can react, and further facilitates the dissolving of the acid and the base. Water is therefore an essential part of the chemical leavening process.

The melting of the lipid coatings takes place between the range of 110° F. and 165° F. In order for internal baking temperatures to achieve this temperature however, it is often necessary to heat the dough to temperatures far exceeding this range. For example, in order for the internal temperature to reach 110° F., it may be necessary to heat the exterior to 300° F. This causes several difficulties in baking the dough. When bread dough is heated to these high temperatures, water tends to evaporate out of the dough, especially at the dough's exterior, i.e., top, bottom, and edges. The lack of water in the dough prevents the dissolution of the agents, and, therefore, prevents or retards the chemical reaction to form CO₂. Consequently, little or no leavening occurs. Moreover, with the absence of water, the agents may simply bake entrapped in the dough, resulting in discrete and localized brown and black spots where they have been unable to contact a leavening reactant. Brown spots will occur in basic spots (pH is greater than 7) in the dough, and black spots will occur in areas of acidic pH (pH≦7).

In order to solve these problems and create a more efficient encapsulation for leavening agents, artisans have tried reducing the thickness of the coating. A thinner coating requires less heat to melt the coating and expose the leavening agent encapsulated therein. Thus, coated leavening ingredients were produced in the form of a particle consisting of between approximately 70% and 95% leavening agent (acid or base) by weight, and correspondingly between approximately 30% and 5% lipid coating by weight. Additionally, leavening ingredients were made smaller to provide additional surface area; i.e. so that less moisture would be required to hydrate the ingredient. These smaller ingredient sizes range between about 50 microns and about 100 microns.

Additional problems arose with the thin coatings, however. While protection for the leavening agent was somewhat adequate, brown spots still occurred regularly because there was still a lack of water in the dough because of the extreme temperatures required to heat and dissolve the coating. One solution to this was to reduce the particle size, as mentioned above, thus providing more surface area in order to quicken the melting of the coating. Brown spots still regularly occurred in the dough however. The thin coatings were then made even thinner (until they consisted of about 95% leavening agent and 5% coating). Coatings this thin however were inadequate to protect the leavening agent, and premature leavening often resulted.

As the coating level decreased, therefore, discoloration of the bread decreased. Corresponding with the decrease in discoloration however, came an increase in premature leavening of the bread because the thinner coatings provided inadequate protection for the leavening agent.

There are many known methods of coating food particles in order to provide protection. Some examples include fluid bed techniques, modified fluid bed techniques, and spray chilling techniques. Fluid bed encapsulating techniques are very prevalent in encapsulation for leavening agents. In fluid bed and modified fluid bed technology, a substrate particle is positioned in a zone where it is suspended in an ambient atmosphere as a singular and discrete particle. Once the particle has been suspended, a microdroplet of coating material is applied to the particle. The microdroplet of coating material is generally applied at a level where it can only flow over a portion of the substrate material. A series of microdroplets therefore follows the initial application and is required to build up successive layers of coating material to essentially seal off the substrate material from the environment. This results in an encapsulated product which has a low or controllable leach rate. This had previously proven to be the most efficient coating system as the method forms a continuous coating which is substantially non-porous in order to protect the leavening agents from premature activation.

Spray chilling as a coating method has been considered inadequate since the coating resulting therefrom is not substantially continuous and non-porous. Thus, spray chilling has generally been avoided as a viable technique for protective coating of leavening agents.

It is therefore, an intention of the present invention to provide, among other things, an improved ingredient for leavening bread dough, the improved ingredient possessing a coating which allows hydration of the chemical leavening agent while also providing adequate protection for the leavening agent prior to baking.

### SUMMARY OF THE INVENTION

The present invention includes an ingredient and method for an improved leavening mechanism for bread doughs. The ingredient is a chemical leavening agent encapsulated within a microporous lipid coating. The method includes a process of creating a more efficient leavening system by incorporating a leavening ingredient, which is essentially a leavening agent with a microporous lipid coating. A bread dough composition prepared using the ingredient and method set forth above is also part of the present invention. Preferably, the bread dough composition is a muffin, biscuit dough, or pizza shell composition.

The ingredient of the present invention is a chemical leavening agent encapsulated with a microporous lipid coating. The microporous lipid coating is hydrophobic at room temperature. Upon heating of the ingredient, the coating permits a first hydration with the addition of heat sufficient to saturate the coating of the ingredient. Upon further heating of the ingredient, the coating permits a second hydration of the ingredient with the addition of heat sufficient to melt the coating. The ingredient typically has a first hydration between a temperature of 80° F. and 90° F. The ingredient permits the second hydration typically between the temperatures of 90° F. and 100° F. The coating of the ingredient should comprise at least about 25% by weight of the ingredient. Preferably, the coating should comprise at least about 40% by weight of the ingredient, and most preferably at least about 50% by weight of the ingredient. The chemical leavening agent of the ingredient can be an acid or a base. The ingredient typically has a mean particle size from about 50 microns to about 100 microns. The coating of the ingredient may be selected from the group consisting of monoglycerides, diglycerides, triglycerides, waxes, organic esters, and combinations thereof, and the coating is most preferably a hydrogenated vegetable oil.

The bread dough composition of the present invention contains the claimed ingredient in a range from about 0.5% to 5% by weight of the bread dough, and preferably from about 1% to 3% by weight. Most preferably, the ingredient is present in the bread dough at about 2% by weight.

As a result of the present invention an improved bread dough with improved physical characteristics has been provided. The improved characteristics include an increase in volume yield, and a finished bread product with a reduced amount of discoloration, i.e. brown and black spots.

It is a further advantage of the present invention to provide a bread dough with an improved ingredient which allows hydration of a coated leavening agent at a reduced temperature.

It is a still further advantage of the present invention to provide an improved method for baking a bread dough wherein the bread dough retains water as a result of hydration of the lipid coating of the improved ingredient.

For a better understanding of the present invention, together with other and further objects and advantages, reference is made to the following detailed description, taken in conjunction with the accompanying examples and drawings, and the scope of the invention will be pointed out in the appended claims. The following detailed description is not intended to restrict the scope of the invention by the advantages set forth above.

### DETAILED DESCRIPTION

The present invention is an ingredient for leavening a bread dough, and a method for leavening a bread dough with the new ingredient, as well as the bread dough including the improved ingredient. The improved leavening agent is an acid or base encapsulated with a microporous lipid coating. The term “microporous” as used herein refers to a coating which is sufficiently impermeable to prevent migration of water thereacross at room temperature, yet is sufficiently permeable to allow hydration of an encapsulated agent with the introduction of energy, usually in the form of heat.

Preferably the microporous lipid coating is formed by spray chilling techniques. Structurally speaking, the microporous lipid coating of the present invention refers to a coating of non-uniform size and width parameters. Preferably, the coating has reticulated passages which are believed to allow the retention of water within the microporous structure while preventing contact with the encapsulated substrate. With the addition of an appropriate amount of heat, the coating melts, thereby exposing the encapsulated agent to water retained in the coating. The reticulated passages are, therefore, sufficiently porous to permit entry of and retention of water at some temperatures, yet sufficiently microscopic to prevent contact between the water and the leavening agent substrate until the addition of additional heat.

It may also be said that the ingredient of the present invention has a first temperature of hydration which allows saturation of the reticulated passages within the microporous coating. The ingredient has a second temperature of hydration which further melts the coating and allows contact between the leavening agent and the rest of the bread dough, thereby allowing contact of acid and base and leavening of the dough. There is a corresponding delta (Δ) heat of hydration between the first and second temperatures of hydration of the present ingredient. The Δ heat of hydration provides a temperature range which permits retention of water while still protecting the leavening agent.

The microporous lipid coating of the present invention is presently provided by spray-chilling techniques. In the spray-chilling techniques of the present invention, the particle to be coated is mixed with the coating to form a colloidal suspension. When lipids are utilized as a coating material, heat is applied to the mixture along with a continuous agitation to prevent solidification of the lipid. The mixture is then pumped with pressure through a single nozzle into a closed chamber. The mixture is substantially atomized into a substrate/lipid combination mainly due to the high pressure combined with the small size of the nozzle. As the atomized combination is propelled into the chamber, a spherical particle will be formed. In the present invention, the atomized combination is propelled in a substantially upward projection. The atomized combination may also be propelled horizontally into the chamber.

The atomization chamber may optionally include fixtures attached thereto which provide for the introduction of certain gases into the chamber which facilitates hardening of the lipid. Some gases which may be introduced to the chamber include carbon dioxide and nitrogen. The atomized mixture congeals in the chamber and hardens into the ingredient of the present invention.

Other techniques may be employed which provide the same mixing and hardening (e.g., congealing) characteristics as described above. It is intended to include such teachings within the scope of the present invention.

The encapsulation process of the present invention permits the artisan to prepare an ingredient which has a lipid coating in an amount greater than successfully used in the past. The microporous coating is permitted to encapsulate the leavening agent in increased amounts because the protection provided by the coating does not create a water-impermeable leavening agent, but rather a “water-resistive agent” at low temperatures. Whereas previous continuous and non-porous coatings, which are encapsulated by fluid bed techniques, prevent water contact, the present coating merely delays water contact until the optimum time. The ingredient of the present invention is comprised of at least about 25% of lipid coating by weight. Preferably the coating comprises at least about 40% by weight of the ingredient, and most preferably the coating comprises at least about 50% by weight of the ingredient.

The coating of the present invention also allows the use of particles of increased size. The ingredient of the present invention has a mean particle size from about 10 microns to about 300 microns. Preferably from about 25 microns to about 200 microns, and most preferably in the range of between 50 microns and 100 microns.

The coating is an edible material which remains intact prior to baking, but melts within normal baking temperatures. Preferably the coating melts at a temperature greater than 125° F. The coating material must be compatible with other dough ingredients. Examples of such coating materials are vegetable fat, gelatin, vegetable gum, but is preferably hydrogenated vegetable oil. Other coatings include, but are not limited to, a material selected from the group consisting of lipid materials such as, but not limited to, mono- di, and triglycerides, waxes and organic esters derived from animals, vegetables, minerals, and modifications thereof Examples include glycerol triesterates, such as soybean oil, cottonseed oil, canola oil, carnuba wax, beeswax, bran wax, tallow, and palm kernel oil.

Many different acids and bases may be used as the leavening agent in the present invention. Examples thereof include sodium aluminum phosphate, sodium acid pyrophosphate, monocalcium phosphate, and ammonium bicarboante.

Generally, the leach rate of an ingredient used in this capacity is considered to be critical to success. Leach rate as used herein is defined as the rate at which an encapsulated agent seeps out from its encapsulation. The leach rate of the coating of the ingredient of the present invention is important because it measures how much acid or base will be released from the coating over the course of time. The leach rate of the ingredient of the present invention is relatively high. This would lead a person skilled in the art to believe that it would not make an effective encapsulant. It has been surprisingly found, however, that despite having a high leach rate, the microporous coating provides an effective encapsulant.

### EXAMPLES

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

A number of sample particles were coated and the leach rates of the particles were taken in order to illustrate this point. The results are shown in Table I. As indicated in Table I, Sample No. 1 was coated with the inventive microporous coating and had a leach rate of 95%. This would seem to indicate that the acid or base would be released from the coating very easily which would lead to a premature release of the leavening agent in the baking of the dough, which would lead to undesirable results as previously mentioned. Sample No. 1 however, was surprisingly found to release at the appropriate time and to be a proper leavening agent as it led to total consumption of the leaving agent particulate.

Sample No. 2 was constructed by prior art fluid bed coating technique, but was the same composition as particle 1. Particle 2 had a leach rate of only 25%, however, which would seem to indicate the proper protection for a leavening agent. The coating however, proved to be too protective as the leavening agent was not fully released in the dough, which resulted in brown spots in the finished baked product.

Sample No. 3 was also coated by prior art fluid bed coating technique, which provides a substantially continuous coating. Sample No. 3 possessed a greater percentage of the leavening agent, (85% sodium bicarbonate) and less of the coating agent (15% vegetable oil). Sample No. 3 had a leach rate of 15% which indicates that it provides even more protection than Sample No. 2. Not surprisingly, the large particle was also not fully released in the finished baked product and resulted in a dough with brown spots indicating the remnants of the leavening agent in the dough. Sample No. 4 was also prepared with the prior art fluid bed technique which results in a substantially continuous coating. Sample No. 4 consisted of 70% leavening agent (sodium bicarbonate) and 30% coating, (vegetable oil). Sample No. 4 was the most protective of the examples with a leach rate of only 5%. It was also not surprisingly found that brown spots resulted in the dough as the coating did not allow full release of the leavening agent.

TABLE I

| Sample | | | | |
|---|---|---|---|---|
| No. | Coating | Ingredient | Leach Rate | Results |
| 1 | microporous | 50% sodium | 95% | Good release in |
| | | bicarbonate | | baking |
| | | 50% vegetable | | |
| | | oil | | |
| 2 | continuous | 50% sodium | 25% | Not fully released |
| | | bicarbonate | | in baking of |
| | | 50% vegetable | | dough-brown |
| | | oil | | spots (basic) |
| 3 | continuous | 85% sodium | 15% | Not fully released |
| | | bicarbonate | | in baking of |
| | | 15% vegetable | | dough-brown |
| | | oil | | spots |
| 4 | continuous | 70% sodium | 5% | Not fully released |
| | | bicarbonate | | in baking of |
| | | 30% vegetable | | dough-results in |
| | | oil | | brown spots |

### Example I

A biscuit was prepared using the following specifications: 4.0 grams non-fat dry milk, 4.0 grams of salt, and 4.0 grams of sucrose were dissolved in 110.0 grams of water. 200.0 grams of flour and 8.0 grams of the leavening agents were then blended for approximately two minutes. 40.0 grams of hydrogenated shortening mix was then added and mixed for another one minute with the flour. The flour was then mixed with the milk, salt and sugar solution and 40.0 grams of shortening flakes was then added to the complete mix. The resulting composition was mixed for 30 seconds. The total mixture was then heated, or rolled out to approximately 9mm and then cut with a biscuit cutter. The dough was then placed on a flat surface and put into a freezer. After freezing for a suitable time, the dough is removed from the freezer and place on an ungreased baking sheet, and then baked an oven heated to 400° F. for approximately 17 to 20 minutes.

The components and their quantity by weight are shown in the following table.

TABLE II

| Ingredient | Grams |
|---|---|
| Cake Flour (sifted) | 200.0 |
| Hydrogenated Shortening | 40.0 |
| Non-fat Dry Milk | 4.0 |
| Salt | 4.0 |
| Sucrose | 4.0 |
| SALP | 4.0 |
| MCP | 2.05 |
| Coated sodium bicarbonate | 8.0 |
| Water | 110.0 |
| Shortening flakes | 40.0 |
| Total | 412.05 |

What is claimed is:

1. An ingredient for leavening bread dough comprising a chemical leavening agent encapsulated with a microporous lipid coating.

2. An ingredient according to claim 1, wherein said coating is hydrophobic at room temperature.

3. An ingredient according to claim 2, wherein said coating permits a first hydration of said ingredient with the addition of heat sufficient to saturate said coating.

4. An ingredient according to claim 3, wherein said coating permits a second hydration of said ingredient with the addition of heat sufficient to melt said coating.

5. An ingredient according to claim 3, wherein said coating permits said first hydration at a temperature of 85° F.

6. An ingredient according to claim 4, wherein said coating permits said second hydration at a temperature of 95° F.

7. An ingredient according to claim 1, wherein said coating comprises at least about 25% by weight of said ingredient.

8. An ingredient according to claim 7, wherein said coating comprises at least about 40% by weight of said ingredient.

9. An ingredient according to claim 8, wherein said coating comprises at least about 50% by weight of said ingredient.

10. An ingredient according to claim 1, wherein said chemical leavening agent is a base.

11. An ingredient according to claim 1, wherein said chemical leavening agent is an acid.

12. An ingredient according to claim 1 wherein said ingredient has a mean particle size from about 50 microns to about 100 microns.

13. An ingredient according to claim 1 wherein said microporous lipid coating is selected from the group consisting of monoglycerides, diglycerides, triglycerides, waxes, organic esters, and combinations thereof.

14. An ingredient according to claim 13 wherein said microporous lipid coating is hydrogenated vegetable oil.

15. A bread dough composition comprising a chemical leavening ingredient, said ingredient comprising a chemical leavening agent with a microporous lipid coating.

16. A bread dough composition according to claim 15 wherein said microporous lipid coating is hydrophobic at room temperature.

17. A bread dough composition according to claim 16 wherein said coating of said ingredient permits a first hydration of said ingredient with the addition of heat sufficient to saturate said coating.

18. A bread dough composition according to claim 17 wherein said coating of said ingredient permits a second hydration of said ingredient with the addition of heat sufficient to melt said coating.

19. A bread dough composition according to claim 17 wherein said coating permits said first hydration at a temperature of 85° F.

20. A bread dough composition according to claim 18 wherein said coating of said ingredient permits said second hydration at a temperature of 95° F.

21. A bread dough composition according to claim 15 wherein said microporous lipid coating comprises at least about 25% by weight of said improved ingredient.

22. A bread dough composition according to claim 21 wherein said microporous lipid coating comprises at least about 40% by weight of said improved ingredient.

23. A bread dough composition according to claim 22 wherein said microporous lipid coating comprises at least about 50% by weight of said improved ingredient.

24. A bread dough composition according to claim 15 wherein said chemical leavening agent is a base.

25. A bread dough composition according to claim 15 wherein said chemical leavening agent is an acid.

26. A bread dough composition according to claim 15 wherein said chemical leavening ingredient has a mean particle size from about 50 microns to about 100 microns.

27. A bread dough composition according to claim 15 wherein said microporous lipid coating is selected from the group consisting of monoglycerides, diglycerides, triglycerides, waxes, organic esters, and combinations thereof

28. A bread dough composition according to claim 27 wherein said microporous lipid coating is a hydrogenated vegetable oil.

29. A bread dough composition according to claim 15 wherein said ingredient comprises from about 1% to about 3% by weight of the total bread dough.

30. A bread dough composition according to claim 15 wherein said bread dough is a muffin dough.

31. A method of making bread with a more efficient leavening system comprising:
incorporating a leavening ingredient comprising a leavening agent with a microporous lipid coating.
